(19) United States
(12) Patent Application Publication
(10) Pub. No.: US 2021/0377227 A1
(43) Pub. Date: Dec. 2, 2021

(54) PRIVATE WEB SYSTEMS AND USES THEREOF

(71) Applicant: Shuang Chen, Somers, NY (US)

(72) Inventor: Shuang Chen, Somers, NY (US)

(21) Appl. No.: 17/066,406

(22) Filed: Oct. 8, 2020

Related U.S. Application Data
(60) Provisional application No. 62/912,289, filed on Oct. 8, 2019.

(51) Int. Cl. H04L 29/06; H04L 29/08

(52) U.S. Cl. CPC H04L 63/0414; H04L 63/10; H04L 67/2833; H04L 67/2838

(57) ABSTRACT

Provided herein is a system for protecting the privacy of internet users. The system is supported by a distributed internet service technology and has an application module with a group of decentralized applications and an online access portal, a data module for handling user privacy data between application and the internet, and a cloud module that supports all applications, middleware, data and online access services across all user-designated personal online devices.

### CROSS-REFERENCE TO RELATED APPLICATIONS

This non-provisional application claims benefit of priority under 35 U.S.C. § 119(e) of provisional application U.S. Ser. No. 62/912,289, filed Oct. 8, 2019, the entirety of which is hereby incorporated by reference.

### BACKGROUND OF THE INVENTION

### Field of the Invention

The present invention relates to a system and method for protecting the privacy information while enhancing online experiences for users over Internet.

### Description of the Related Art

Internet users today are exposed with almost no privacy online, from who you are to where you go, from what you searched, viewed, liked or not liked, to what you shared with family, friends or even personal doctors. Those privacy related information should be strictly protected as personal property with clear consent for intended use. But today most of them are controlled, exploited, and used by other parties to monitor, influence and even manipulate the users lives. This invention, referred to as the “Private-web” here, let users to take back the control of their online privacy while enhancing their online experiences.

The Private-web invention leverages the previously patented distributed internet service (DIS) technology, and provides a comprehensive yet easy-to-use software solution to completely solves the user privacy protection problem. The user may buy and own the software, or may pay a subscription fee to use the software without owning it, the so-called SaaS (Software as a Service) model.

The Private-web is the first complete solution than any other privacy-protection solution on market today. It utilizes the patented distributed internet service technology to enable the decentralized applications that execute only on user's devices and are dedicated to serve the user. The online user's privacy data ranges broadly. The prior art only addresses certain subsets of it, thus failing to provide a complete solution.

After over two decades of online e-commerce development in global market, most of the users' online activities heavily rely to applications for social media network, online commerce, online search and other interactive online services from news, education, entertainment etc. Most of them are free to use. However, typically in exchange of the “free” usage or service, the users have to agree to give up their certain privacy information to those application service providers. Those providers acquire the privacy information and exploit them for profits from targeted advertisement to personalized sales, etc. This is exactly the business model that makes many of this generation of online application service providers hugely profitable with the reach of billions of online users worldwide. Those providers have become trillion-dollar companies, unprecedented in civilization history.

Furthermore the lack of privacy information protection to billions of online users today has left a huge crack to the parties who would manipulate the information for malicious purpose. The Private-web solution offers users an option to protect their online privacy, and it will greatly improve the way that users interact and enjoy their online life style. This invention expects to benefit billions of online users worldwide.

### SUMMARY OF THE INVENTION

This invention provides a solution to the root problem of online privacy data protection. Online users today reply on various internet applications that are controlled and operated by third-party providers via their servers, such as social media networking, search, information, shopping, travel, entertainment, sports, education, online investment, and others. Online users access those internet applications via web browser or the local thin client (often referred to as APPs) provided by the application owner, some even pre-installed on the PC, laptop, smartphone or pads. Those application owners acquire all the user privacy related data (Type 1, 2 and 3) through their control of those applications via the servers and clients or web pages. Therefore, online users today have no power to protect their privacy related data.

The Private-Web software provides online users with the user-controlled decentralized applications, the user-controlled intelligent online accesses, and used-controlled management of all types of privacy related data through the Smart Cloud (trademark pending) services.

The PrivateWeb consists of MyApp, MyData, and MyCloud

1. MyApp provides a group of decentralized applications, such as MyFriends which provides social media networking and messaging functions, that execute on MyCloud and are fully owned and controlled by the user, not by any other parties.

2. MyData manages all privacy related data and provides personalized data intelligence for mycloud using a proprietary “data sphere” technology

3. MyCloud a personal cloud that supports all Private-Web applications, middleware, data and online access services across all user-designated personal online devices. It is responsible for all the distal assets life-cycle services, including distribution, updating, synchronization, and purging between the user SmartCloud Service: the 24×7 full hosting service.

MyApp consists of:

### Decentralized Applications

User-controlled, i.e. with no control from other servers over Internet, so all the data associated by those DApps are protected.
Downloaded or via SaaS (Software-as-a-Service), free or for a fee.
Include popular online functions that the users wish to protect their privacy data, such as social media networking. SmartCloud provides in SaaS model.

### Online Access Portal

A portal application consisting of a personalized UI, a secured browser engine such as one based on the open-source Gecko (en.wikipedia.org/wiki/Gecko_(software))

It is noted that using PrivateWeb does not prevent the user from using the worldwide web as usual where no privacy protection is provided by the PrivateWeb. For instance, a user may want to share privacy related data voluntarily in Facebook, use Google for search, or use the Internet Explorer to shop directly on amazon.com.

MyData consists of DataSphere, Database and Interface. DataSphere is an intelligent data proxy service for MyApp, and controls the interface layer for connection to the Internet.

1. Major MyData functions include

2. Protect User Privacy Related (UPR) Data;

3. Provide Intelligent Data Proxy Service;

4. Provide Intelligent Web Proxy Service, and

5. Secure Data Storage.

Major DataSphere functions include

1. Protect UPR data:

| Category | Source | DataSphere Functions |
|---|---|---|
| TYPE 1 | User generated | Web proxy, DApp service, capture and |
| | | manage |
| TYPE 2 | Application | Web proxy, interface service, capture and |
| | generated | manage |
| TYPE 3 | Server captured | Web proxy, DApp service, capture and |
| | | manage |

2. Personalized Data Intelligence:

Track and analyze the in- and out-bound data using the language engine similar to those used for speech processing along with the personalized “value matrix” to provide intelligent in- and out-bound data services, meanwhile continuously augment the personalized data service. (Distributed Internet Service (DIS) and related Multiple-dimension Value Matrix technology).

3. Digital Asset Life-cycle Management:

Creation, storage, revision, retrieve, consented usage, purge, etc., and every life-cycle action is also recorded and stored together along with the asset.

MyData Use Case 1: MyData Protects Online Search Keywords Privacy and Provides Personalized Intelligent Data Service.

Step 1: User searches “Nike male sneaker”.

Step 2: My Data acts.
1. DataSphere protects the search key words privacy by generating a group of DS search keywords;
2. Interface uses the DS search keywords to query multiple online search engines and collects results:
   “Nike sneaker”
      “Nike male sneaker”
         “Nike female sneaker”
         “Best-selling sneaker male”.

Step 3: MyData acts (with continued reference to the schematic in Step 2):
1. Interface sends collected search results to DataSphere
   Results for “Nike sneaker”
      Results for “Nike male sneaker”
         Results for “Nike female sneaker”
         Results for “Best-selling sneaker male”.
2. DataSphere sorts all results, discards the “female sneaker” and “Nike sneaker” results, sends back the relevant results to MyApp Results for “nike male sneaker” along with results for “best selling sneaker male”.

MyData Use Case 2: My Data Protects IP Address Data Privacy (with continued reference to the schematic in Case 1, Step 1):

Step 1: User requests to go online.

Step 2: MyData acts:
1. DataSphere protects online IP address as privacy data by using VPN strategy, e.g. “select the best VPN server, preferably a different one from last online connection.”
2. Interface connects to a fast VPN server, if possible different from the last one.

MyData Use Case 3: MyData Filters Intelligently Incoming Web Pages (with continued reference to the schematics in Case 1, Steps 1 and 2, respectively)
Step 1: User requests to access an online shopping web page via the Personalized Online Access Portal.
Step 2: MyData acts:
   Receives the URL and requests the web page along with user provided parameters with the web proxy within the DataSphere.
Step 3: MyData acts:
   The web proxt receives the web page, extracts the presentation content to organize a new web page, filters out any harmful element and forward the new “clean” web page to MyApp.

MyCloud provides support for

1. Online privacy protection across all the user-designated online devices.

2. All the clients of the user's MyApp.

MyCloud is the user's own Private Cloud Service among all the user's online devices and MyApp's clients. It is based on the inventor's patented “Distributed Internet Service” system (DIS) technology incorporated herein by reference.

Major MyCloud Functions include:
1. Providing the full stack of enterprise-grade miniature middleware support (including web server, app server, DBMS, etc.) for MyApp and MyData on all the user-designated personal online devices, fixed or mobile, such as PC, laptop, smartphone and home or mobile appliances.
2. Providing the distributed internet services of the life-cycle functions for all digital assets between the MyCloud host and its clients.

MyCloud Hosting has three choices:
1. SmartCloud hosting: A full-service MyCloud operation, where mycloud is hosted and operated 7×24 by the Smartcloud service provider. the user has the full ownership and control to MyApp, MyData and MyCloud.
2. MyCloud fixed self-hosting: MyCloud is hosted on a user-designated personal computer or home appliance with a fixed Internet connection. The user is responsible to all the setup and operation management of MyCloud, MyApp and MyData. All privacy data are physically located on the user's designated devices.
3. MyCloud mobile self-hosting: MyCloud is hosted on a user-designated personal mobile device. The mobile device has no fixed IP. All privacy data are physically located on the user's designated devices

SmartCloud provides the full service for the Private-Web including
1. Set-up and host
User only needs to sign-up, follow the instruction to download a small software onto each desired online device, and the entire PrivateWeb will be automatically installed, configured and ready to run on those devices, which includes:
a) User-selected decentralized applications (DApps) and the supporting middleware,
b) Personalized Online Access Portal,
c) MyData and MyCloud Management Panel,
d) Automatic distribution, deployment and update of all PrivateWeb software,
e) Secured privacy data backup/restore by user-selected services,
f) Internet security services for all PrivateWeb devices.

2. 7×24 MyCloud operation
a) The full set of digital asset services for all applications and data between the PrivateWeb host, all PrivateWeb devices and clients
b) Internet security, data security, real-time monitoring and alert, real-time cloud backup

3. Continuous enhancement
Personalized intelligent data proxy service, DApps, Online Portal access, other services via business partners.

In summary Private-Web enables the user-owned social networking applications and protection to access to rest online applications, thus effectively enabling the user to control all the privacy related data. The Private-Web also provides the personalized data intelligent services, actively searching, analyzing and filtering the data from other online sources based on the user's behavior, better and better serving the user's needs. The Private-Web protects the user's online privacy and provides the best personalized intelligent online services.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 describes the categories of user-privacy related (UPR) online data, which this invention focuses on to protect.

FIG. 2 illustrates the Private-Web system structure that consists of subsystems of MyApp, MyData, MyCloud and the Smart Cloud service.

FIG. 3 illustrates the MyApp subsystem structure, which includes one or more decentralized applications that are supported by Mydata subsystem.

FIGS. 4A-4C illustrate the MyData subsystem structure. FIG. 4A includes the DataSphere component, Interface component and a database component. FIGS. 4B-4C illustrate that the MyData subsystem interacts separately with MyApp and Internet.

FIG. 5 illustrates the major functions as described in the Detailed Description of the Inventions section.

FIG. 6 illustrates the MyCloud subsystem structure. MyCloud service covers all the devices that a user's Private-Web resides.

FIG. 7 illustrates the Decentralized application component of MyApp subsystem.

FIG. 8 illustrates the Online Access Portal component of MyApp subsystem.

FIG. 9 illustrates the DataSphere component of MyData subsystem.

FIG. 10 illustrates the Interface component of MyData subsystem.

FIG. 11 illustrates the MyCloud subsystem components.

FIG. 12 illustrates one implementation of the Smart Cloud service (i.e. Distributed Internet Service, or DIS)

FIG. 13 illustrates another implementation of the Smart Cloud service (i.e. Distributed Internet Service, or DIS)

FIG. 14 illustrates the scaling of the decentralized application Myfriend over Internet.

FIG. 15 illustrates the flowchart of the scaling of the decentralized application MyFriend over Internet as shown in FIG. 14.

### DETAILED DESCRIPTION OF THE PRESENT INVENTION

The articles “a” and “an” when used in conjunction with the term “comprising” in the claims and/or the specification, may refer to “one”, but is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

The present invention is directed to a system for protecting privacy data of an online user over an internet connection comprising an application module comprising a plurality of decentralized applications and an online access portal in electronic communication with an internet device; a data module in electronic communication with the application module and configured to protect user privacy related (UPR) data, provide intelligent data proxy service, provide intelligent web proxy service and secure data storage, said data module comprising a data sphere; a database; and an interphase; and a cloud module comprising a user-end distributed internet service in electronic communication with the data module and configured to execute the decentralized applications and securely communicate over the internet connection.

The Private-Web is a software system that mainly resides and executes on the online devices of an internet user. This software acts as the main entry for the user to conduct activities on internet, provides personalized protection to the privacy information meanwhile intelligent information process for the online user. Compared with the typical way that a user relies on for conducting activities on internet today, that is via a browser or third-party applications, which has almost no protection to the user's privacy information, the Private-web solves the much needed yet complicated online privacy protection problem meanwhile enables the intelligent process both for the output and input information tailored for the user's personal needs.

Typical internet devices may include smartphone, PC, laptop, internet appliances used for home, office or car. An internet user may use one or more of such devices to conduct internet activities.

The online privacy protection is a complicated problem as it relates to a broad range of information and ways to conduct online activities. Especially since the wide spread usage of internet generated the current generation of e-commerce during the past quarter century, almost of all major online activities today result in the giving up some of a user's online privacy information. One of the major e-commerce business models is to provide free online service in exchange for the service provider to acquire certain information from the user and to send the user certain information, mainly advertisement or some sort of targeted information. In fact, this business model has been hugely successful in global market that it has generated a number of tech giants earning billions of dollars of annual profits with over trillion-dollar market valuation, first time in the civilization history. Those service providers have several billions of users over the internet worldwide, and constantly acquire and mining the ocean size of data from their users' privacy information, meanwhile online users' behaviors are more and more being closely monitored, influenced and even manipulated by the service providers.

For example, when a user uses a free search engine application trying to find a pair of sneakers, the keywords used, the type of online device, the IP address, the geo location as well as the interactive response to the in-page advertisement, etc. will be captured by the service provider.

When a user uses Facebook to connect to friends, the text entered, pictures uploaded, etc. will all be shared with Facebook by agreeing to the “Terms and Conditions” of using their free social networking application at the time the user download their application and created the account. Facebook owns global, perpetual and royalty-free rights to use all the user contributed content. In addition, by the same agreement the user has agreed for Facebook to collect just about every piece of information about the user when using this application, including but not limited to name, sex, age, online interactive behavior, IP, online device, geo location, contact list, etc. Also the Facebook has access to all the pictures, videos, documents, messages, camera, microphone, calendar, notes, etc.

Privacy information is personal property protected by constitution. Online users today giving up privacy information in exchange of conducting online activities is because of lack of the effective online services that enable them to conduct necessary applications without giving up privacy information. This invention provides a complete solution for online users to conduct necessary application online without giving up privacy information. This invention can be further combined with other solutions such as data storage, cyber security services and digital right protection to expand into various solution bundles that meet the needs of billions of online users today. The complete online privacy protection solution will change the way how the current generation of e-commerce is conducted and has tremendous potential market value.

The Private-Web software system consists of four subsystems, i.e. MyApp, MyData, MyCloud and Smart Cloud Service (also referred to as Distributed Internet Services or DIS). See FIG. 2.

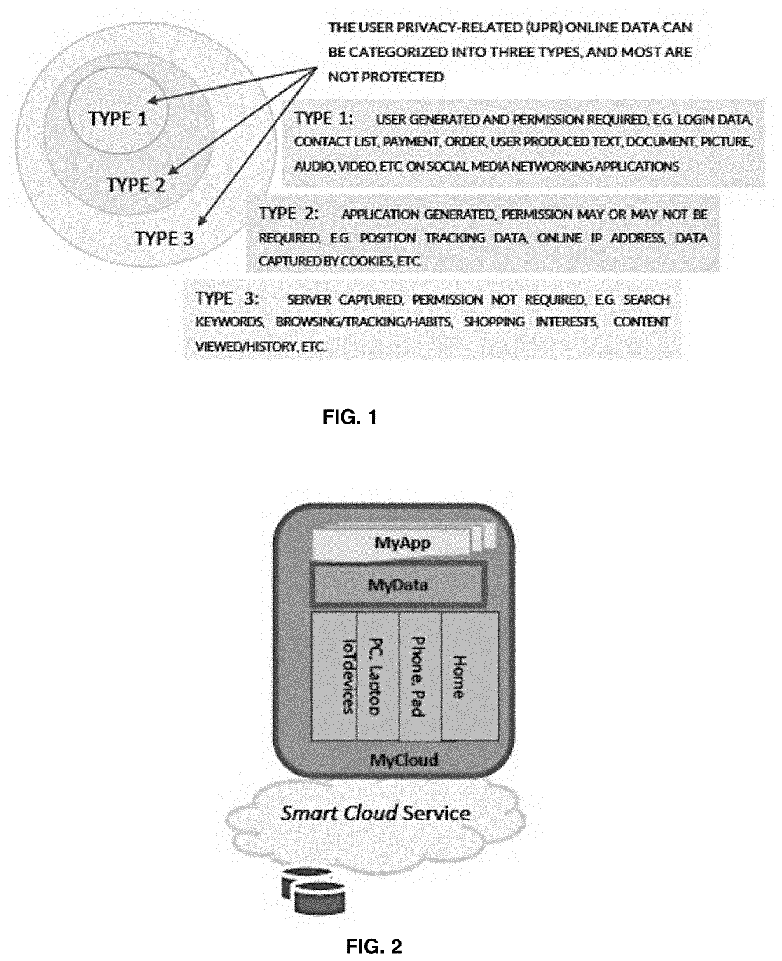

By categorizing all user privacy related (UPR) information or data into three categories, i.e. 1) user-generated, 2) application-generated, and 3) server captured (see FIG. 1), this invention provides three major means in order to completely protect the privacy information for the online user. The first one is to enable decentralized applications using the Distributed Internet Services (DIS) system (also referred to as Smart Cloud Service) to establish the personal cloud service for the user, so that the user has the choice not to use those, free or charged, online applications that heavily collect user privacy information or contain user privacy information, such as social media and networking as well as online communication. The second one is to control intelligently the user-generated output information meanwhile intelligently process the information acquired over Internet, so that the privacy information will not be directly exposed while conducting online activities, such as searching or browsing online. The third one is to control the application-generated privacy information such as geo location, online IP address, etc. so that they will not be directly exposed while conducting online activities.

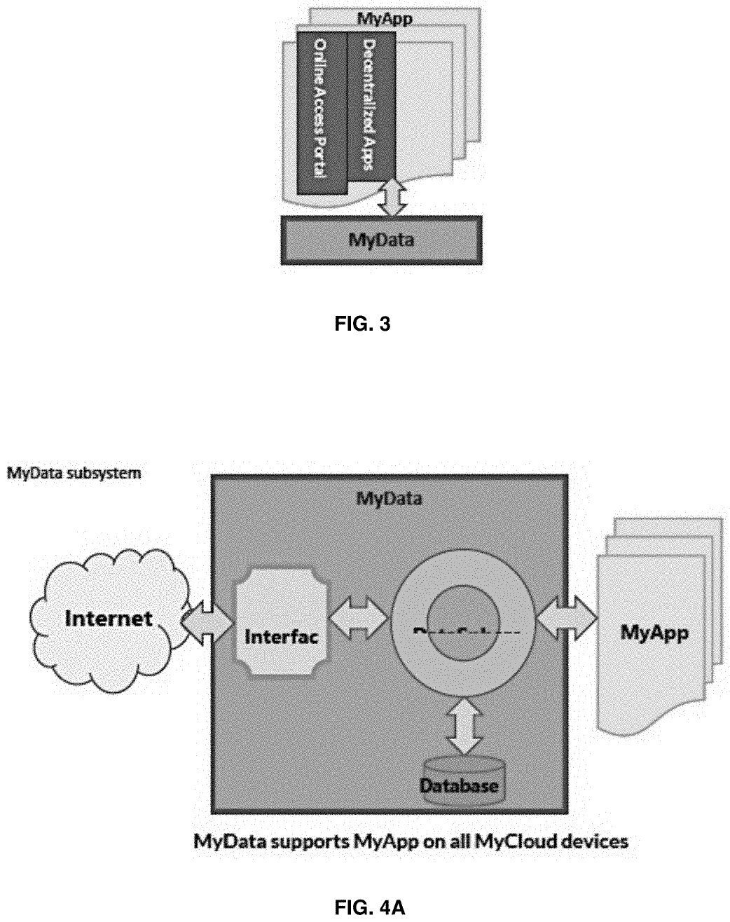

MyApp subsystem consists of two major components: 1) Decentralized applications (or DApp), and 2) Online Access Portal, see FIG. 3.

Web application itself is prior arts, either existing open-source software or developed by software developers, not part of this invention. However, to enable a regular web application to become a DApp in online user's own personal cloud environment using the Smart Cloud service is one of the major parts of this invention. What separates regular web application with DApp is that web application is web-server centric, owned by the application provider aiming to serve a large amount of user over internet. DApp is owned by the user aiming to serve a smaller group of friends. So there will be no application provider online to monitor and capture the user privacy information by using the DApp.

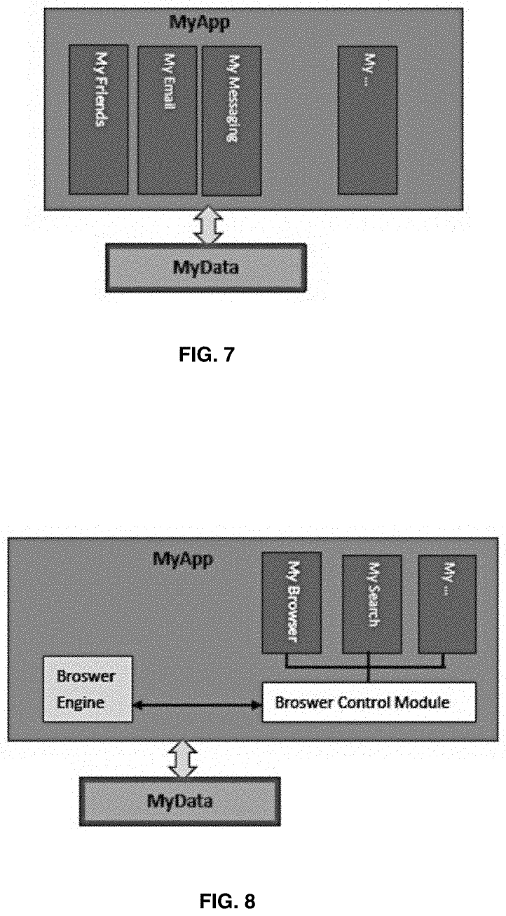

The DApp component can contain any application that is needed by the online user, see FIG. 7. One application would be social media networking, called MyFriend in this invention. Facebook, WhatsApp, Youtube, etc. are all well-known open-source software available online. They can be adapted relatively easily for personal friend circle with a much smaller scale, e.g. typically from tens to thousands of online friends but rarely millions or hundreds of millions or basically not billions (note: Facebook application has over 3 billion users worldwide). The maximal number of users in a DApp can be defined and limited in development of such application.

To enable web application to become a DApp will be described later in the sections about MyCloud and Smart Cloud Service, and the DIS patent portfolio.

Online Access Portal component consists of mainly the user-interface (UI), Browser Control Module and Browser Engine, see FIG. 8. This component provides the intelligent control of user output information when browsing or searching online and intelligent processing of information acquired from over Internet. Instead of using directly a third-party browser software such as Microsoft Internet Explorer or Microsoft Edge, Google's Chrome or Firefox from Mozilla, a user clicks the icon of MyBrowser which invokes Browser Control Module for browsing certain URLs over Internet. The Browser Control Module is responsible for calling the Browser Engine with proper input data supplied by MyData subsystem (see below). Similarly, the user may click the MySearch icon which invokes Browser Control Module for an online search. The input data may include URLs and any necessary data such as search key words or parameters. The user inputs the original data and the Browser Control Module passes them along with usage flags (browsing or searching or others) to MyData. MyData processes them and provides with proper data to the Browser Control Module along with usage flag. The Browser Control Module uses the processed data and the usage flag to invoke the Browser Engine to conduct online activities. When the Browser Engine acquires data from proper Internet servers and passes them to the Browser Control Module. The Browser Control Module processes those data along with the usage flag into proper internal format and sends them to MyData for intelligent process. The Browser Control Module receives processed data from MyData and composes the resulting web page for UI, either browsing or searching. Therefore, Online Access Portal isolates all user input data from directly sending out over Internet, and presents the resulting data to the user from the intelligent processing by MyData which also isolates the data from over Internet (including web pages and data contained) from directly presented by the web browser to the user.

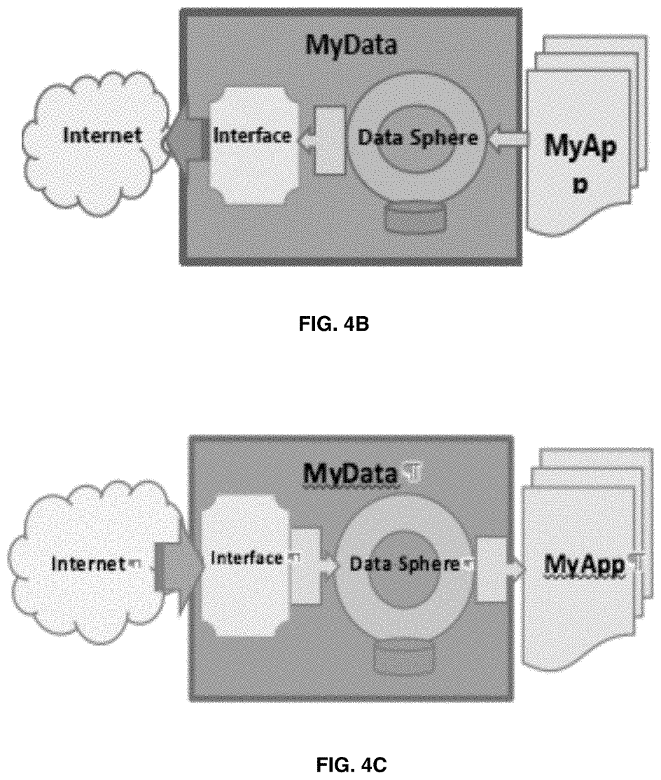

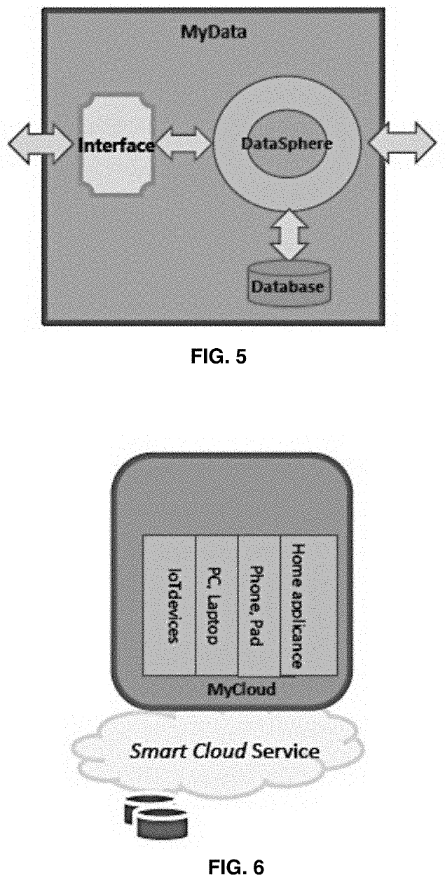

MyData subsystem consists of also two major components: 1) DataSphere, and 2) Interface, see FIGS. 4A-4C. Its major functions include intelligent data processing and system Interface control, see FIG. 5.

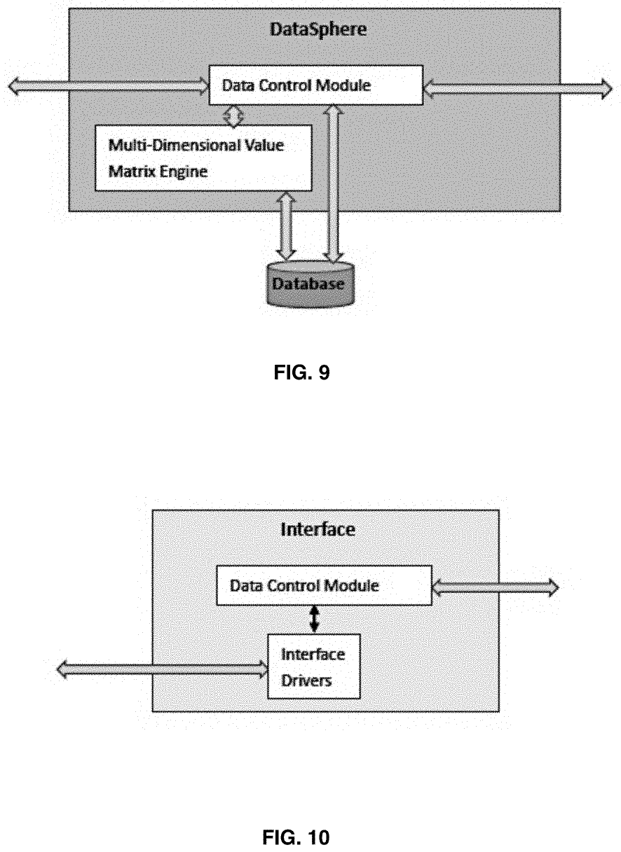

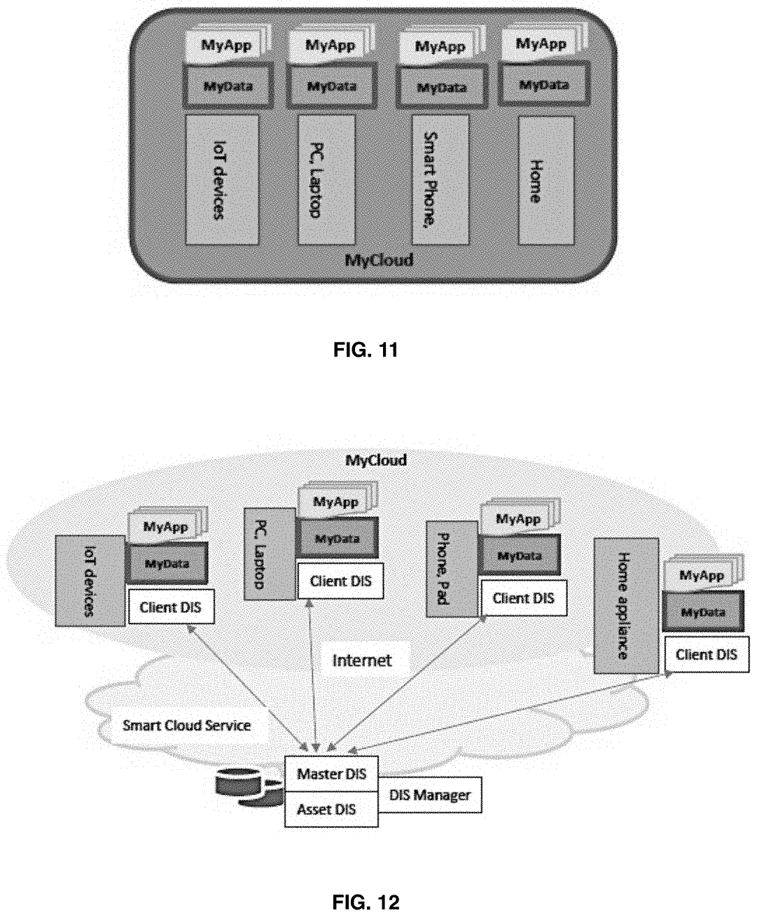

The DataSphere component takes input data from MyApp subsystem along with the usage flag, then processes the data accordingly, see FIG. 9. For the web searching flag, it performs data camouflage with intelligence from the Multiple Dimensional Value Matrix Engine (see U.S. Pat. No. 10,089,583, “Distributed Cloud Services System and Uses Thereof”) for both outgoing (searching keywords) and incoming (search results) data. For web browsing flag, it performs certain data camouflage using the intelligence also from the same Value Matrix Engine for both outgoing and incoming data. For instance, if browsing an online shopping website (e.g. amazon.com), the user provided key words will be camouflaged similarly to the web searching case. For any incoming web page with corresponding flag, DataSphere is responsible for filtering the content to remove malicious code and data. Web page filtering is prior arts as there are many technologies for examining and removing malicious code and data inside a web page. DataSphere is also responsible for rules to camouflaging IP address and GPS position. It provides the rule-based parameters to the Interface component and uses the feedback parameters from the Interface component to provide to MyApp for any needs.

The Interface component is responsible to control certain system drivers including VPN for IP connection, GPS position, etc., see FIG. 10. VPN services are provided by vendors and the technologies for connecting VPN is prior arts. GPS position parameter is provided by operating system of online devices. Prior arts are available for faking GPS position in commonly used operating systems including iOS, Android and Windows. The Data Control module takes input from DataSphere, controls the Interface Drivers to perform IP connection or fake GPS position, and send feedback data back to DataSphere.

The database is prior art such as using the enterprise-grade PostgreSQL.

MyCloud subsystem is mainly based on the Distributed Internet Services (also referred to as Smart Cloud Service). The major function is to support the distributed execution of MyApp and MyData among the various online devices of the user as well as the online devices of any and all clients of MyApp Decentralized Applications such as MyFriend. MyCloud provides a personal cloud service over Internet for the specific MyApp and MyData for the user as part of the user's private web. The user owns his/her MyApp and MyData that run across all the related online devices.

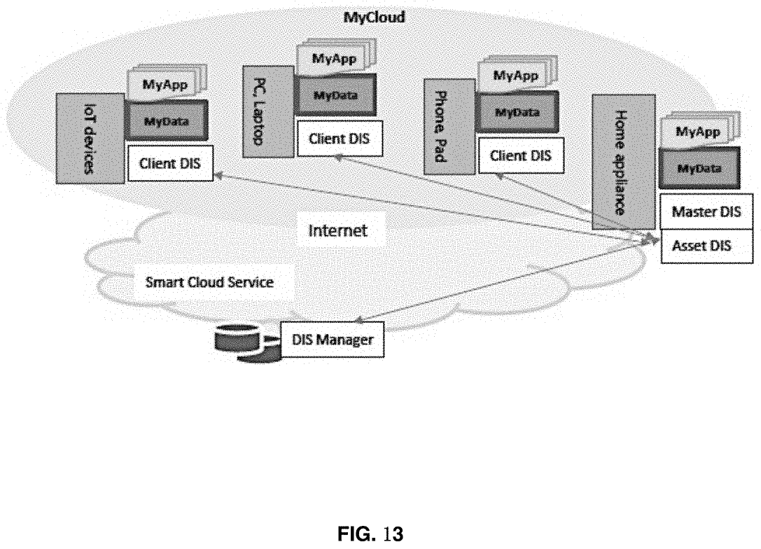

The Distributed Internet Services, or the Smart Cloud Service, conduct complete life cycle service for all digital assets of MyApp and MyData, including distribution, deployment, execution, synchronization, updating and purge. The service is deployed as a cloud service from the DIS management server. The Smart Cloud Service for MyCloud can be implemented based on each user's choice and online device environment with customized configuration. See FIGS. 12 and 13.

The nested scale-up of MyApp Decentralized Application such as MyFriend is based on each user own MyApp and MyCloud service with his/her friends that sign up as “Friend”. The relationship is always “Host-and-Client”, i.e., the owner of the MyFriend application is the host and whoever signs in as “friend” is the client of this MyFriend application. The host and client are served by the owner's MyCloud service.

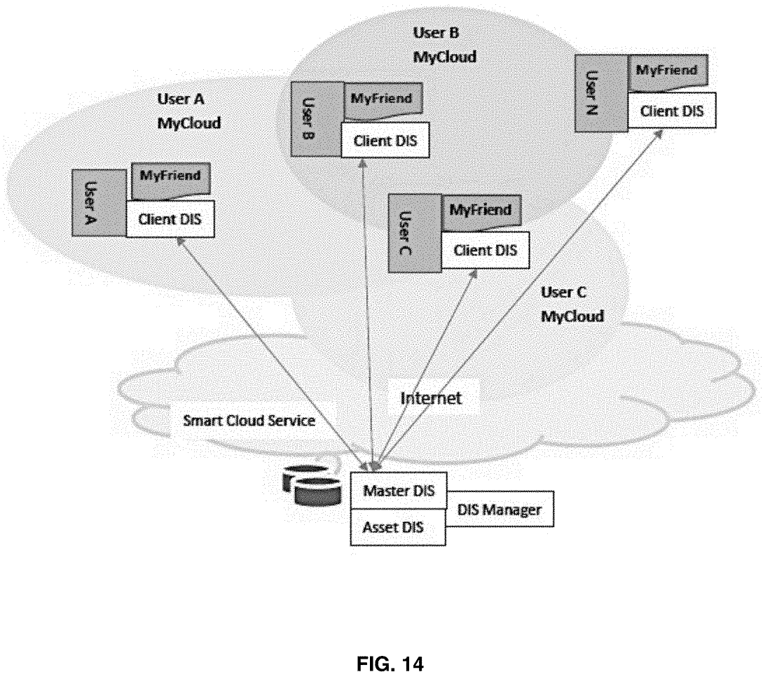

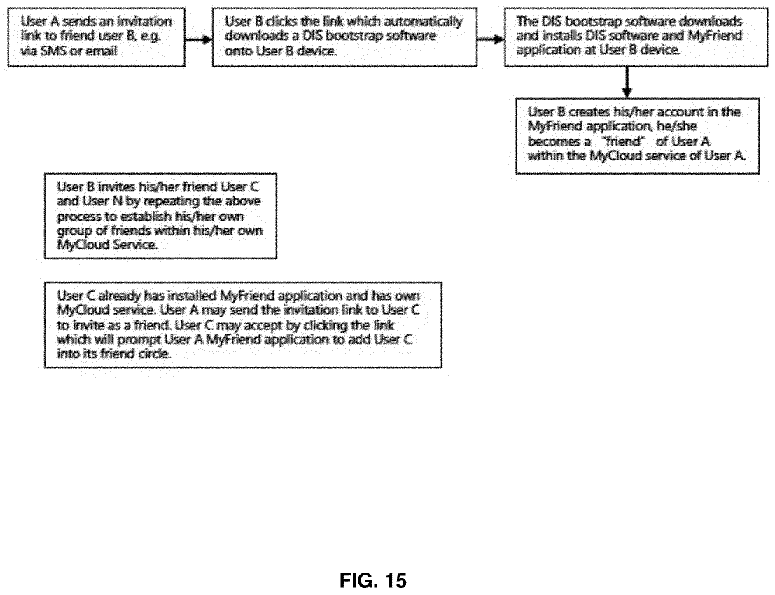

A client can have his/her own MyFriend and invite his/her own friends where he/she is the host of his/her own MyFriend application with his/her own MyCloud service. Different MyFriend applications and served by different MyCloud service, in general, have different digital content and different cloud structure due to different group of devices and network environment. The same client DIS on a user's device may serve more than one set of digital assets with respective service requirements. See FIGS. 14 and 15.

Based on the six degree of separation theory, people can be easily connected through the nested MyClouds through the world and information (such as news posting) can be distributed and re-distributed across the nested MyFriend circles to reach almost any large number of crowds. This kind of decentralized nested connection and information distribution is better than today's server-centric model as the information distribution can be.

What is claimed is:

1. A system for protecting privacy data of an online user over an internet connection comprising:
an application module comprising a plurality of decentralized applications and an online access portal in electronic communication with an internet device;
a data module in electronic communication with the application module and configured to protect user privacy related (UPR) data, provide intelligent data proxy service, provide intelligent web proxy service and secure data storage, said data module comprising:
a data sphere;
a database; and
an interphase; and
a cloud module comprising a user-end distributed internet service in electronic communication with the data module and configured to execute the decentralized applications and securely communicate over the internet connection.
